(19) United States
(12) Patent Application Publication
(10) Pub. No.: US 2015/0010850 A1
(43) Pub. Date: Jan. 8, 2015

(54) ELECTROCHEMICAL DEVICE

(71) Applicant: U.S. Army Research Laboratory ATTN:RDRL-LOC-I, Adelphi, MD (US)

(72) Inventors: Rongzhong Jiang, Oliney, MD (US); Deryn Chu, Potomac, MD (US)

(73) Assignee: U.S. Army Research Laboratory ATTN:RDRL-LOC-I, Adelphi, MD (US)

(21) Appl. No.: 13/933,435

(22) Filed: Jul. 2, 2013

(51) Int. Cl. H01M 8/02

(52) U.S. Cl. CPC H01M 8/02
USPC 429/523

(57) ABSTRACT

Embodiments of electrochemical devices are provided herein. In some embodiments, an electrochemical device may include a housing having an inner volume; a first outer electrode disposed within the inner volume and on a first side of the housing; a second outer electrode disposed within the inner volume on a second side of the inner volume opposite the first side; a first inner electrode disposed between the first outer electrode and the second outer electrode; and a second inner electrode disposed between the first inner electrode and the second outer electrode.

### GOVERNMENT INTEREST

The invention described herein may be manufactured, used and licensed by or for the U.S. Government.

### TECHNICAL FIELD

Embodiments of the present invention generally relate to electrochemical devices. More particularly, embodiments relate to an air breathing hydrogen/air fuel cell with a four (4) electrode cell design whose peak power density is increased by about sixty (60) percent when compared with traditional two (2) electrochemical cell designs.

There is an ever increasing demand for portable and lightweight electricity generation with high power density since more and more frequently the development of electronic devices follows a reduction in size accompanied by new power demanding functions for use in medical devices, phones, cameras, laptop computers, automobiles and the like.

### BACKGROUND OF THE INVENTION

Conventional electrochemical devices, for example, fuel cells, batteries or the like, typically utilize two electrodes (an anode and a cathode) to convert stored chemical energy into electrical energy. However, the inventors have observed that in order to increase a capacity or power density of a conventional electrochemical device, the size of the electrochemical device must be increased accordingly. As such, the inventors have observed that in some applications, the size of the electrochemical cell needed to meet the capacity or power density requirements of the application makes the electrochemical device an impractical power supply in terms of size and weight.

Thus, the inventors have provided embodiments of improved electrochemical devices.

### SUMMARY

Accordingly, it one object of this invention to provide a four-electrode electrochemical cell for enlarging the capacitance and reducing the impedance of the cell in comparison to traditional two-electrode electrochemical cells. Another objective is to provide higher power density fuel cells and batteries for both civilian and military applications.

Embodiments of these novel electrochemical devices are provided herein. In some embodiments, an electrochemical device may include a housing having an inner volume; a first outer electrode disposed within the inner volume and on a first side of the housing; a second outer electrode disposed within the inner volume on a second side of the inner volume opposite the first side; a first inner electrode disposed between the first outer electrode and the second outer electrode; and a second inner electrode disposed between the first inner electrode and the second outer electrode.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1 depicts an electrochemical device in accordance with some embodiments of the present invention.

FIG. 2 depicts an electrode configuration for use in an electrochemical device in accordance with some embodiments of the present invention.

FIG. 3 is a diagram showing the components of an air-breathing hydrogen/air fuel cell with a four (4) electrode configuration according to one embodiment.

FIG. 4 illustrates the positional styles (Style A and Style B) of the outer electrode and the inner electrode in accordance with some embodiments of the present invention.

FIG. 5 illustrates the effect of the novel design on cell performance (Power) in accordance with embodiments of the present invention.

FIG. 6 illustrates the effect of the novel design on cell performance (Power) in accordance with embodiments of the present invention.

FIG. 7 illustrates the effect of the novel design on cell performance (Power) in accordance with embodiments of the present invention.

FIG. 8 illustrates the effect of the novel design on cell performance (Power) in accordance with embodiments of the present invention.

FIG. 9 illustrates the alternating current impedance of a four electrode cell versus a two electrode cell for air-breathing hydrogen/air fuel cells at about 20° C.

The figures are not drawn to scale and may be simplified for clarity. it is contemplated that elements and features of one embodiment may be beneficially incorporated in other embodiments without further recitation.

### DETAILED DESCRIPTION

Embodiments of electrochemical devices are provided herein. The inventive electrochemical devices advantageously provide increased power density and capacity as compared to similarly sized conventional electrochemical devices.

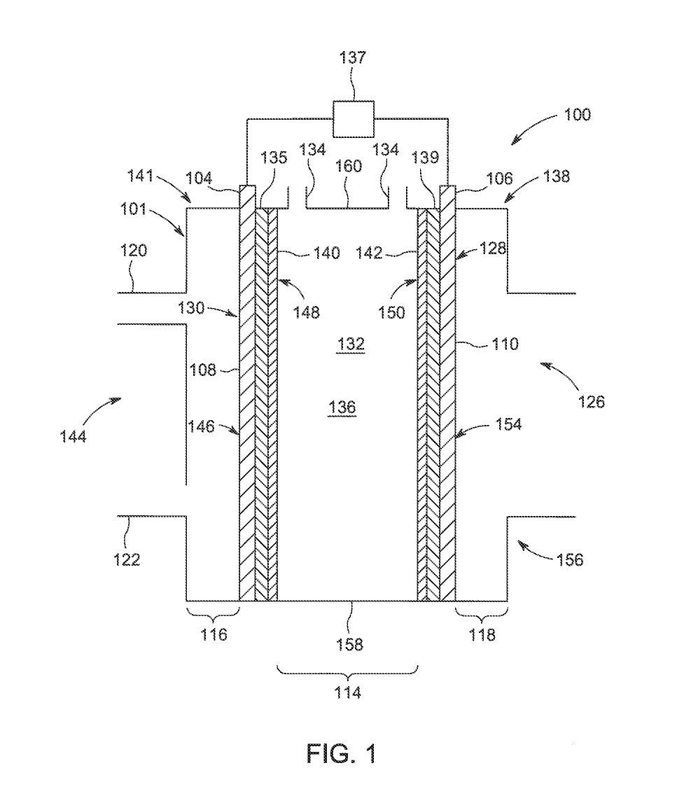

Referring to FIG. 1, in some embodiments, an electrochemical device 100 may generally comprise a housing 101 having an inner volume 132, a first outer electrode 108, a second outer electrode 110, a first inner electrode 140 and a second inner electrode 142. In some embodiments, an electrolyte 136 is disposed within the inner volume 132 of the housing 101. In some embodiments, the first outer electrode 108 and second outer electrode 110 may each comprise an upper portion 104, 106 that extends from the housing to facilitate electrically coupling the first outer electrode 108 and second outer electrode 110 to a load 137. The electrochemical device 100 may be any device capable of converting chemical energy to electrical energy, for example, such as a fuel cell, wet cell battery, dry cell battery, electrochemical capacitor, or the like.

The housing 101 may be fabricated from any electrically insulating and non-reactive material capable of containing the first outer electrode 108, second outer electrode 110, first inner electrode 140, second inner electrode 142 and, when present, the electrolyte 136. For example, in some embodiments the housing 101 may be fabricated from a polymer, glass, ceramic, or the like.

In some embodiments, the housing 101 may comprise one or more features to allow fuel to enter, and waste products to exit, the electrochemical device 100 to facilitate reactions necessary for the production of electrical energy from the electrochemical device 100. For example, in some embodiments, an inlet 120 and outlet 122 may be formed in the first side 141 of the housing 101 to allow for a flow of fuel through the first side 141 of the housing 101 to a back side 130 of the first outer electrode 108. The fuel may be any type of gas or liquid fuel capable of providing electrons upon reaction with a catalyst. For example, in some embodiments, the fuel may be a hydrogen containing gas such as hydrogen (H₂), methanol CH₃OH, ethanol CH₃CH₂OH, or a hydrocarbon. In some embodiments, a window 126 may be formed in a second side 138 of the housing 101 to allow for a flow of atmospheric air or oxygen (O₂) to contact a back side 128 of the second outer electrode 110,

In operation, the fuel is supplied to the back side 130 of the first outer electrode 108 via the inlet 120 of the first side 141 of the housing 101. The fuel reacts with the first outer electrode (anode) 108 causing a disassociation of the fuel into protons and electrons. Unused fuel exits the housing 101 via the outlet 122. The electrons flow out of the electrochemical cell 100 to provide power to, for example, the load 137. The protons flow through the electrolyte 136 to the second outer electrode 110 (cathode). At the second outer electrode 110, the oxygen receives electrons that flow back into the electrochemical cell 100 from the load 137 and oxygen provided to the back side 128 of the second outer electrode 110 via the window 126 in the second side 138 of the housing 101 to form water with the protons, which may then be removed from the electrochemical cell 100 as waste.

The first outer electrode 108 may be fabricated from any material capable of facilitating the disassociation of the fuel as described above. For example, in some embodiments, for example, where the first outer electrode 108 may comprise a carbon (C) containing substrate (e.g., a gas diffusion layer), for example, a carbon (C) cloth comprising a catalyst to facilitate electrooxidation of the fuel. In some embodiments, the carbon containing substrate may be disposed on a current collecting plate. In such embodiments, the current collecting plate may be fabricated from, for example, a non-corrosive metal or graphite. The catalyst may be any type of catalyst capable of facilitating the aforementioned electrooxidation. For example, the catalyst may comprise a noble metal, such as platinum (Pt), or nickel (Ni). In some embodiments, the catalyst may be a layer disposed on the substrate or a powder embedded within a matrix of the substrate.

The second outer electrode 110 may be fabricated from any material capable of facilitating an oxygen electroreduction. For example, in some embodiments, the second outer electrode 110 may be a carbon (C) containing substrate (e.g., a gas diffusion layer), for example, a carbon (C) cloth comprising a catalyst to facilitate electro-reduction of oxygen. In some embodiments, the carbon containing substrate may be disposed on a current collecting plate. In such embodiments, the current collecting plate may be fabricated from, for example, a non-corrosive metal or graphite. The catalyst may be any type of catalyst capable of facilitating the aforementioned oxygen electroreduction. For example, the catalyst may comprise platinum (Pt) or silver (Ag). In some embodiments, the catalyst may be a layer disposed on the substrate or a powder embedded within a matrix of the substrate.

The electrolyte may be provided to the inner volume 136 via for example, one or more inlets 134 disposed in the housing 101. The electrolyte 136 provides ionic conductivity for ion transport and induces reactions at the electrode (first outer electrode 108 and/or second outer electrode 110)/electrolyte 136 interface. Accordingly, the electrolyte 136 may be any non-gas permeable material capable of conducting ions from the first outer electrode 108 to the second outer electrode 110. In some embodiments, the electrolyte 136 may be a solid, for example, such as a polymer, for example, perfluorosulfinic acid (PFSA), a liquid, such as an aqueous solution of potassium hydroxide (KOH), sodium hydroxide (NaOH), sulfuric acid (H₂SO₄) or the like, or a gel, such as a gel polymer for example, polyacrylonitrile (PAN), polymethylmethacrylate (PMMA), a polyvinylide fluoride (PVdF), or the like.

The inventors have observed that in conventional electrochemical devices the electrolyte generates impedance during the electrochemical reactions. However, as the impedance increases, the power density and capacity of the electrochemical device decrease. Accordingly, the inventors have discovered that providing the first inner electrode 140 and second inner electrode 142 reduces the impedance of the electrolyte 136 and increases electron and ion transfer across the electrolyte 136, thereby increasing the power density and capacity of the electrochemical device 100. For example, in some embodiments, the inventors have observed that by providing the first inner electrode 140 and second inner electrode 142 the power density of the electrochemical device 100 may increase from about 30% to about 60%, or in some embodiments, greater than 60% as compared to similarly sized conventional electrochemical devices. In addition, the inventors have observed that providing the first inner electrode 140 and second inner electrode 142 does not increase the overall size or configuration of the electrochemical cell 100. Thus, the power density of the electrochemical device 100 is increased in a low cost, simple, and scalable manner.

The first inner electrode 140 and second inner electrode 142 may be fabricated from any electric and/or ionic conductive, ion and/or electrolyte permeable material that is non-reactive with the electrolyte 136. For example, in some embodiments, the first inner electrode 140 and second inner electrode 142 may be fabricated from one of non-corrosive metal foam, a metal screen a carbon cloth, or the like. In addition, in some embodiments, the first inner electrode 140 and second inner electrode 142 may be porous to allow the electrolyte 136 to flow through the first inner electrode 140 and second inner electrode 142 and hydrophilic to allow the electrolyte 136 to fully wet or soak the first inner electrode 140 and second inner electrode 142. The first inner electrode 140 and second inner electrode 142 may have any porosity suitable to provide electrolyte permeability while facilitating ion transport. For example, in some embodiments, the first inner electrode 140 and second inner electrode 142 may have a pore size of a few nanometers to a few micrometers.

In some embodiments, each of the electrodes (e.g., the first inner electrode 140, first outer electrode 108, second inner electrode 142 and second outer electrode 110 may be secured in place by the housing 101 via, for example, a press fit or fasteners, such as bolts, pins, or the like. The first inner electrode 140 and second inner electrode 142 may be disposed in a position proximate to the respective outer electrodes (e.g., the first outer electrode 108 and second outer electrode 110) within the housing 101 to minimize the impedance of the electrolyte and maximize the flow of ions from the first outer electrode 108 to the second outer electrode 110. In some embodiments, the first inner electrode 140 and second inner electrode 142 may extend from a bottom 158 to the top 160 of the housing 101, such as shown in FIG. 1, In such embodiments, the first inner electrode 140 faces the first outer electrode 108 and the second inner electrode 142 faces the second outer electrode 110. In some embodiments, a distance between the first inner electrode 140 and first outer electrode 108 and a distance between the second inner electrode 142 and the second outer electrode 110 is less than a distance between the first inner electrode 140 and the second inner electrode 142.

In some embodiments, an optional first separator 135 may be disposed between the first inner electrode 140 and the first outer electrode 108 and an optional second separator 139 may be disposed between the second inner electrode 142 and the second outer electrode 110. In such embodiments, each of the first separator 135 and second separator 139 may cover the catalyst disposed in each of the first outer electrode 108 and second outer electrode 110. When present, the first separator 135 and second separator 139 may be fabricated from a porous non-electrically conductive material, for example such as filter paper.

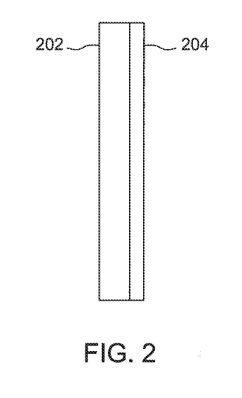

Alternatively, in some embodiments, the outer electrode 202 (e.g., the first outer electrode 108 or the second outer electrode 110) may contact the respective inner electrode 204 (e.g., first inner electrode 140 or second inner electrode 142), such as shown in FIG. 2, In such embodiments, the outer electrode 202 may be fabricated from a hydrophobic material and the inner electrode 204 may be fabricated from a hydrophilic material. In addition, in such embodiments, the inner electrode 204 may cover the catalyst disposed in the outer electrode 202.

Referring back to FIG. 1, in some embodiments, each of the electrodes (e.g., the first inner electrode 140, first outer electrode 108, second inner electrode 142 and second outer electrode 110) may be secured in place by the housing 101 via, for example, a press fit or fasteners, such as bolts, pins, or the like. The first inner electrode 140 and first outer electrode 108 and the second inner electrode 142 and the second outer electrode 110 may be positioned with respect to one another in any manner suitable to minimize the impedance of the electrolyte and maximize the flow of ions from the first outer electrode 108 to the second outer electrode 110.

The first inner electrode 140 and second inner electrode 142 may comprise any dimensions to minimize the impedance of the electrolyte and maximize the flow of ions from the first outer electrode 108 to the second outer electrode 110. For example, in some embodiments, the first inner electrode 140 and second inner electrode 142 may have a thickness of a few micrometers to a few hundred micrometers. For example, embodiments where the first inner electrode 140 and/or the second inner electrode 142 are fabricated from a catalyst coated carbon cloth, one or both of the first inner electrode 140 and second inner electrode 142 may have a thickness of about 200 μm.

Although the housing 101 is described as a unitary component of the electrochemical device 100, the housing 101 may comprise multiple sections that are coupled to one another to form the housing 101. For example, in some embodiments, the housing 101 may comprise a first section 116, a second section 114 and a third section 118. In such embodiments, the first section 116 may comprise the inlet 120 and outlet 122 disposed in a first side 144 and an open second side 146 that seals against the back side 130 of the first outer electrode 108 when assembled. The second section 114 may be a chamber comprising open ends 148, 150 that seal against the first outer electrode 108 and second outer electrode 110 to contain the electrolyte 136 within the second section 114. The third section 118 may comprise the window 126 formed in a first side 156 and an open second side 154 that seals against the back side 128 of the second outer electrode 110 when assembled.

When provided as separate sections as described above, in some embodiments, the first outer electrode 108 may be disposed between the first section 116 and second section 114 and the second outer electrode 110 may be disposed between the second section 114 and the third section 118. In such embodiments, the first outer electrode 108 and the second outer electrode 110 are held in place by pressure applied by the respective surrounding sections when assembled to form the housing 101.

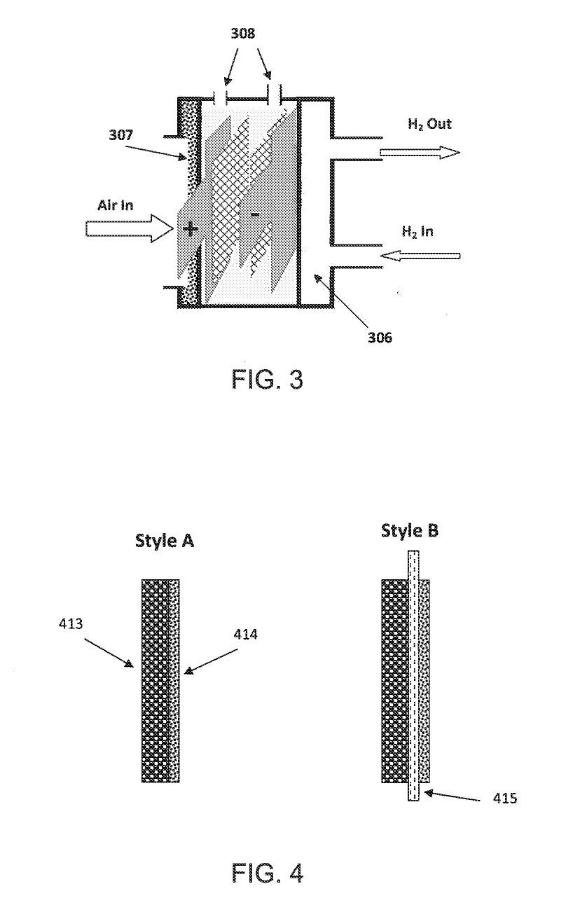

FIG. 3 is a schematic view of an air-breathing hydrogen fuel cell with a four-electrode configuration. Shown is the hydrogen chamber 306, air window 307, and fill hole 308 for the liquid electrolyte.

FIG. 4 describes an example of two different styles of electrode positioning for embodiments of the electrochemical cell. In Style A, the outer electrode 413 and the inner electrode 414 contact each other face to face and wherein the outer electrode 413 may, for example, be hydrophobic and the inner electrode 414 may, for example, be hydrophilic. In Style B the outer electrode 415 and the inner electrode 414 are shown as separated by a porous non-electronic conductive material such as, for example, filter-type papers.

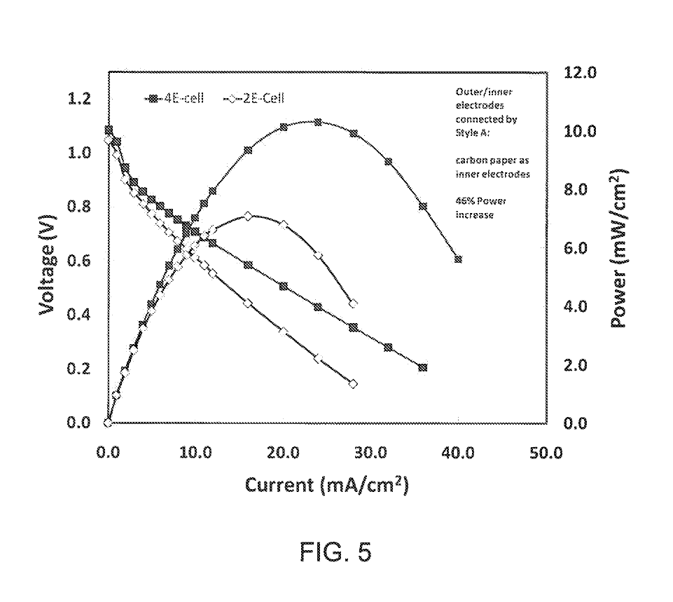

FIG. 5 diagrams the cell performance of one embodiment of the Style A outer/inner electrode positioning. In this example a hydrophilic 0.3 mm carbon paper is used as the inner electrode with a hydrophobic 0.3 mm carbon paper used as the outer electrode. FIG. 5 illustrates the discharge performance of an air-breathing hydrogen/air fuel cell at about 20° C. Other conditions for this example include an about 1 molar KOH solution used as the electrolyte with an electrolyte thickness of about 4 mm, hydrogen flow of about 20 standard cubic centimeters, electrode area of about 5 square centimeters, an about forty percent PtC for both electrodes with a Pt loading of about 0.2 mg/cm².

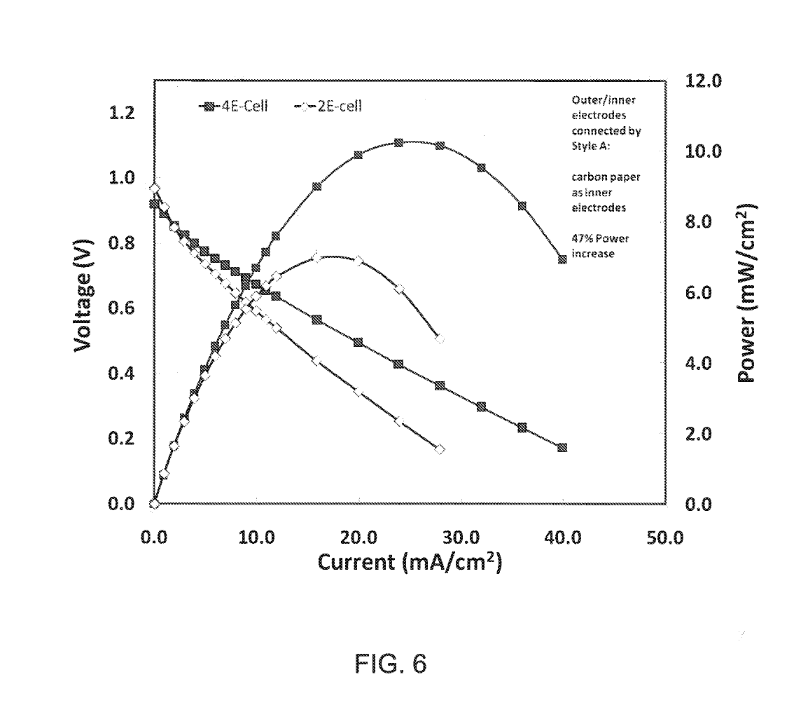

FIG. 6 diagrams the cell performance of one embodiment of the Style A outer/inner electrode positioning. In this example a hydrophilic 0.3 mm carbon paper is used as the inner electrode with a hydrophobic 0.3 mm carbon paper used as the outer electrode. FIG. 6 illustrates the discharge performance of an air-breathing hydrogen/air fuel cell at about 20° C. Other conditions for this example include an about 0.5 molar H₂SO₄ solution was used as the electrolyte with an electrolyte thickness of about 4 mm, hydrogen flow of about 20 standard cubic centimeters, electrode area of about 5 square centimeters, forty percent PtC for both electrodes with a Pt loading of about 0.2 mg/cm².

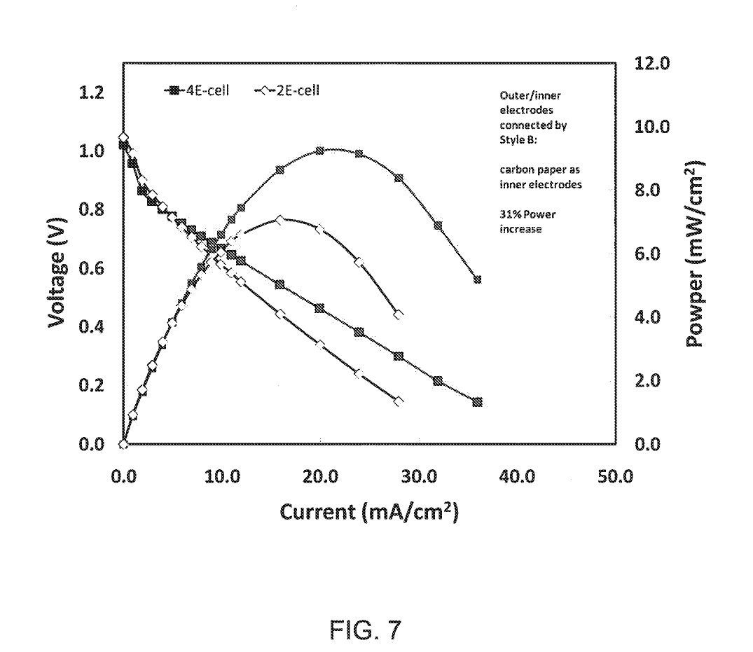

FIG. 7 diagrams the cell performance of one embodiment of the Style B outer/inner electrode positioning. In this example a hydrophilic 0.3 mm carbon paper is used as the inner electrode with a hydrophobic 0.3 mm carbon paper used as the outer electrode. FIG. 7 illustrates the discharge performance of an air-breathing hydrogen/air fuel cell at about 20° C. Other conditions for this example include an about 1 molar KOH solution was used as the electrolyte with an electrolyte thickness of about 4 mm, hydrogen flow of about 20 standard cubic centimeters, electrode area of about 5 square centimeters, forty percent PtC for both electrodes with a Pt loading of about 0.2 mg/cm².

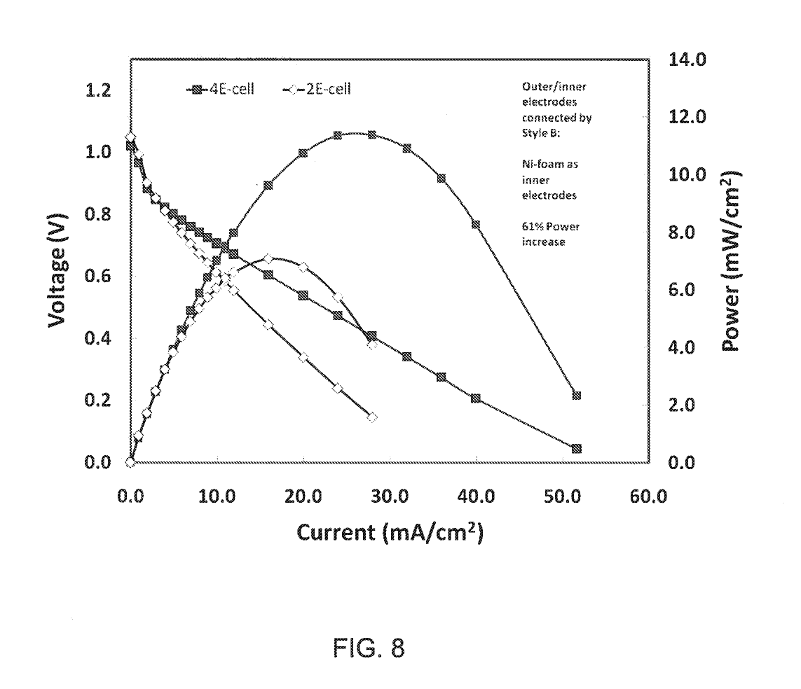

FIG. 8 diagrams the cell performance of one embodiment of the Style B outer/inner electrode positioning. In this example a 0.3 mm nickel foam is used as the inner electrode with a hydrophobic 0.3 mm carbon paper used as the outer electrode. FIG. 8 illustrates the discharge performance of an air-breathing hydrogen/air fuel cell at about 20° C. Other conditions for this example include an about 1 molar KOH solution was used as the electrolyte with an electrolyte thickness of about 4 mm, hydrogen flow of about 20 standard cubic centimeters, electrode area of about 5 square centimeters, forty percent PtC for both electrodes with a Pt loading of about 0.2 mg/cm².

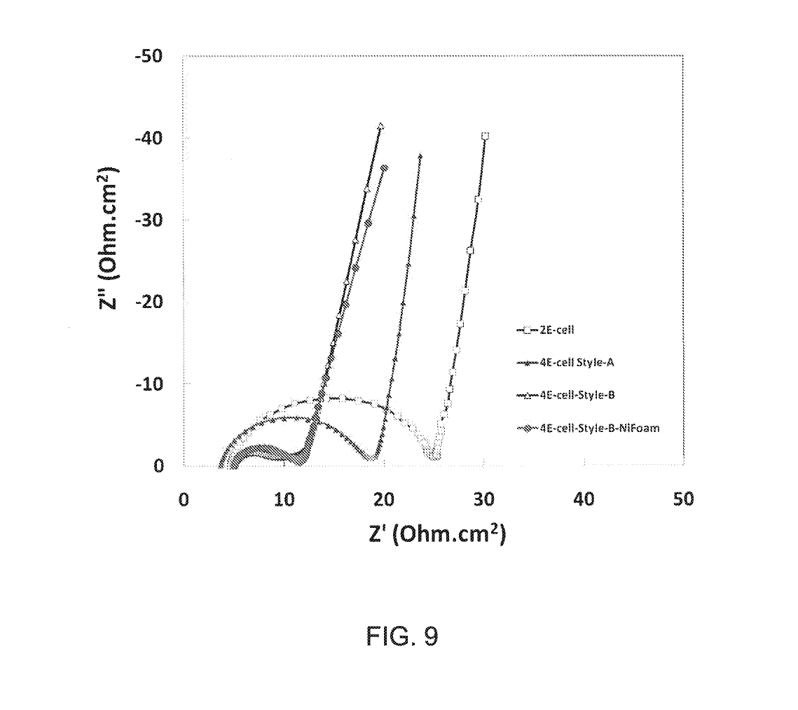

FIG. 9 describes in graph form the AC impedance of four electrode cells versus two electrode cells used for an air-breathing hydrogen/air fuel cell at about 20° C. The impedance was obtained in the absence of hydrogen for the hydrogen chamber.

Thus, an electrochemical device that advantageously provides an increased power density and capacity as compared to similarly sized conventional electrochemical devices has been provided herein.

While the foregoing is directed to embodiments of the present invention, other and further embodiments of the invention may be devised without departing from the basic scope thereof.

1. An electrochemical cell, comprising:
a housing having an inner volume;
a first outer electrode disposed within the inner volume and on a first side of the housing;
a second outer electrode disposed within the inner volume on a second side of the inner volume opposite the first side;
a first inner electrode disposed between the first outer electrode and the second outer electrode; and
a second inner electrode disposed between the first inner electrode and the second outer electrode.

2. The electrochemical cell of claim 1, comprising:
an electrolyte disposed within the inner volume and electrically coupling the first outer electrode, second outer electrode, first inner electrode and second inner electrode.

3. The electrochemical cell of claim 2, wherein the electrolyte is a liquid or gel electrolyte.

4. The electrochemical cell of claim 3, wherein the housing comprises an inlet to provide the electrolyte to the inner volume.

5. The electrochemical cell of claim 3, wherein the first inner electrode and the second inner electrode is submerged in the electrolyte.

6. The electrochemical cell of claim 3, wherein the first inner electrode and the second inner electrode is porous to allow a flow of the electrolyte through the first inner electrode and the second inner electrode

7. The electrochemical cell of claim 1, wherein the first inner electrode and the second inner electrode is fabricated from a non-corrosive metal foam, metal screen, or carbon cloth.

8. The electrochemical cell of claim 1. wherein the first inner electrode and the second inner electrode is disposed up to about 200 pm from a respective first outer electrode and second outer electrode,

9. The electrochemical cell of claim 1, wherein the first inner electrode and the second inner electrode have a thickness of about 100 μm to about 200 μm.

10. The electrochemical cell of claim 1, wherein the first outer electrode and second outer electrode is a carbon containing matrix.

11. The electrochemical cell of claim 10, wherein the first outer electrode further comprises a fuel electrooxidation catalyst.

12. The electrochemical cell of claim 10, wherein the second outer electrode is coated with an oxygen reduction catalyst.

13. The electrochemical cell of claim 1, wherein the housing has an inlet and an outlet formed in a first side of the housing to flow a fuel to a back side of the second outer electrode,

14. The electrochemical cell of claim 13, wherein the fuel is hydrogen (H₂), methanol (CH₃OH), ethanol (CH₃CH₂OH), or a hydrocarbon.

15. The electrochemical cell of claim 1, wherein the housing has a window formed through a second side of the housing to allow a flow of gas to a back side of the second outer electrode.

16. The electrochemical cell of claim 15, wherein the gas is atmospheric air or oxygen (O₂).

17. The electrochemical cell of claim 1, wherein the electrochemical cell is one of a fuel cell, wet cell battery, dry cell battery or electrochemical capacitor.

18. The electrochemical cell of claim 1, further comprising a first separator disposed between the first outer electrode and the first inner electrode and a second separator disposed between the second outer electrode and the second inner electrode.

19. The electrochemical cell of claim 18, wherein the first separator and the second separator are fabricated from a porous non-electrically conductive material.
